(19) United States
(12) Patent Application Publication
(10) Pub. No.: US 2015/0091904 A1
(43) Pub. Date: Apr. 2, 2015

(54) RAY TRACING PROCESSING APPARATUS AND METHOD

(71) Applicant: SAMSUNG ELECTRONICS CO., LTD., Suwon-si (KR)

(72) Inventors: Won-jong LEE, Seoul (KR); Young-sam SHIN, Hwaseong-si (KR); Jae-don LEE, Yongin-si (KR)

(73) Assignee: SAMSUNG ELECTRONICS CO., LTD., Suwon-si (KR)

(21) Appl. No.: 14/261,538

(22) Filed: Apr. 25, 2014

(30) Foreign Application Priority Data
Oct. 2, 2013 (KR) 10-2013-0118129

(51) Int. Cl. G06T 15/06

(52) U.S. Cl. CPC G06T 15/06
USPC 345/426

(57) ABSTRACT

Provided are ray tracing processing method and apparatus. The ray tracing processing method includes detecting, at a ray tracing processing apparatus, a leaf node with which an input ray intersects; and in response to the leaf node being detected, comparing a state of a traversal (TRV) unit and a state of an intersection test (IST) unit and determining whether to feed the ray back to the TRV unit or to transmit the ray to the IST unit.

### RELATED APPLICATIONS

This application claims the benefit under 35 USC 119(a) of Korean Patent Application No. 10-2013-0118129, filed on Oct. 2, 2013, in the Korean Intellectual Property Office, the entire disclosure of which is incorporated herein by reference for all purposes.

### BACKGROUND

1. Field

The following description relates to ray tracing processing methods and apparatuses capable of uniformly maintaining loads between hardware units.

2. Description of Related Art

3-dimensional (3D) rendering refers to image processing where 3D object data is synthesized into an image viewed at a given viewpoint of a camera.

In rendering methods, rasterization, i.e. dividing the primitive into a plurality of fragments, is performed to generate an image while projecting a 3D object into a screen, and ray tracing is performed to generate an image by tracing a path of an incident light according to a ray towards each pixel of the image at a viewpoint of a camera.

In ray tracing, physical properties of light, such as reflection, refraction, or penetration are reflected into a rendering result and a high quality image can be obtained. However, it is difficult to perform high speed rendering due to its relatively large amount of calculations.

Some elements of the process of ray tracing, i.e., require a large amount of calculations. Such elements are generation and traversal (hereinafter referred to as ‘TRV’) of an acceleration structure where scene objects, which are rendering targets, are spatially divided and intersection tests (hereinafter referred to as ‘IST’) between light rays and primitives.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a ray tracing processing method including detecting, at a ray tracing processing apparatus, a leaf node with which an input ray intersects, and in response to the leaf node being detected, comparing a state of a traversal (TRV) unit and a state of an intersection test (IST) unit and determining whether to feed the ray back to the TRV unit or to transmit the ray to the IST unit.

The determining of whether to feed the ray back to the TRV unit or to transmit the ray to the IST unit may include feeding the ray back to the TRV unit, in response to the TRV unit being in an idle state, and transmitting the ray to the IST unit, in response to the IST unit being in an idle state.

The determining of whether to feed the ray back to the TRV unit or to transmit the ray to the IST unit may include determining whether to feed the ray back to the TRV unit or to transmit the ray to the IST unit based on comparing a remnant data amount of an input buffer of the TRV unit and a remnant data amount of an input buffer of the IST unit.

The determining of whether to feed the ray back to the TRV unit or to transmit the ray to the IST unit may include feeding the ray back to the TRV unit, in response to the remnant data amount of the input buffer of the TRV unit being smaller than that of the IST unit, and transmitting the ray to the IST unit, in response to the remnant data amount of the input buffer of the IST unit being smaller than that of the TRV unit.

The method may include detecting a primitive bounding box included in the detected leaf node with which the ray intersects, in response to the ray being fed back to the TRV unit, and determining whether the ray intersects with a primitive included in the detected primitive bounding box, and calculating a hit point, in response to the ray intersecting with the primitive.

The primitive bounding box may include a single primitive.

The method may include determining whether the ray intersects with a primitive included in the detected leaf node, in response to the ray being transmitted to the IST unit, and calculating a hit point, in response to the ray intersecting with the primitive.

The method may include after determining whether the ray intersects with the primitive, comparing a state of the TRV unit and a state of the IST unit and determining whether to feed the ray back to the IST unit or to transmit the ray to the TRV unit, and in response to the ray being transmitted to the TRV unit: detecting a second primitive bounding box included in the detected leaf node with which the ray intersects, and determining whether the ray intersects with a second primitive included in the detected second primitive bounding box, and calculating a second hit point, in response to the ray intersecting with the second primitive.

The method may include determining whether the ray intersects with the second primitive included in the detected leaf node, in response to the ray being fed back to the IST unit, and calculating a second hit point, in response to the ray intersecting with the second primitive.

The node and the primitive bounding box may be rectangles.

In another general aspect, there is provided a ray tracing processing apparatus including a first operator configured to detect a leaf node with which a ray intersects, and in response to the leaf node being detected a first determiner configured to compare a state of a TRV unit and a state of an IST unit to determine whether to feed the ray back to the TRV unit or to transmit the ray to the IST unit.

The first determiner may be further configured to feed the ray back to the TRV unit in response to the TRV unit being determined to be in an idle state, and to transmit the ray to the IST unit in response to the IST unit being determined to be in an idle state.

The first determiner may be further configured to compare a remnant data amount of an input buffer of the TRV unit with a remnant data amount of an input buffer of the IST unit to determine whether to feed the ray back to the TRV unit or to transmit the ray to the IST unit.

The first determiner may be further configured to feed the ray back to the TRV unit in response to the remnant data amount of the input buffer of the TRV unit being smaller than that of the IST unit, and to transmit the ray to the IST unit in response to the remnant data amount of the input buffer of the IST unit being smaller than that of the TRV unit.

The first operator may be further configured to detect a primitive bounding box included in the detected leaf node with which the ray intersects, in response to the ray being fed back to the TRV unit, and a second operator configured to determine whether the ray intersects with the primitive included in the detected primitive bonding box, and to calculate a hit point in response to the ray intersecting with the primitive.

The primitive bounding box may include a single primitive.

The apparatus may include a second operator configured to determine whether the ray intersects with the primitive included in the detected leaf node, in response to the ray being transmitted to the IST unit, and to calculates a hit point, in response to the ray intersecting with the primitive.

The apparatus may include a second determiner configured to compare a state of the TRV unit and a state of the IST unit to determine whether to feed the ray back to the IST unit or transmit the ray to the TRV unit, after determining whether the primitive intersects with the ray, and in response to the ray being transmitted to the TRV unit: the first operator is further configured to detect a second primitive bounding box included in the detected leaf node with which the ray intersects, and the second operator is further configured to determine whether the ray intersects with a second primitive included in the detected second primitive bounding box and to calculate a second hit point, in response to the ray intersecting with the second primitive.

In response to the ray being fed back to the IST unit, the second operator may be further configured to determine whether the ray intersects with the second primitive included in the detected leaf node, and to calculate the second hit point in response to the ray intersecting with the second primitive.

Other features and aspects will be apparent from the following detailed description, the drawings, and the claims.

### BRIEF DESCRIPTION OF THE DRAWINGS

FIG. 1 is a diagram illustrating an example of a ray tracing method.

FIG. 2 is a diagram illustrating an example of a ray tracing processing system.

FIGS. 3A and 3B are diagrams illustrating examples of acceleration structures.

FIG. 4 is a diagram illustrating an example of a ray tracing processing method.

FIG. 5 is a diagram illustrating an example of a ray tracing processing apparatus.

FIGS. 6 and 7 are diagrams illustrating a ray tracing processing.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

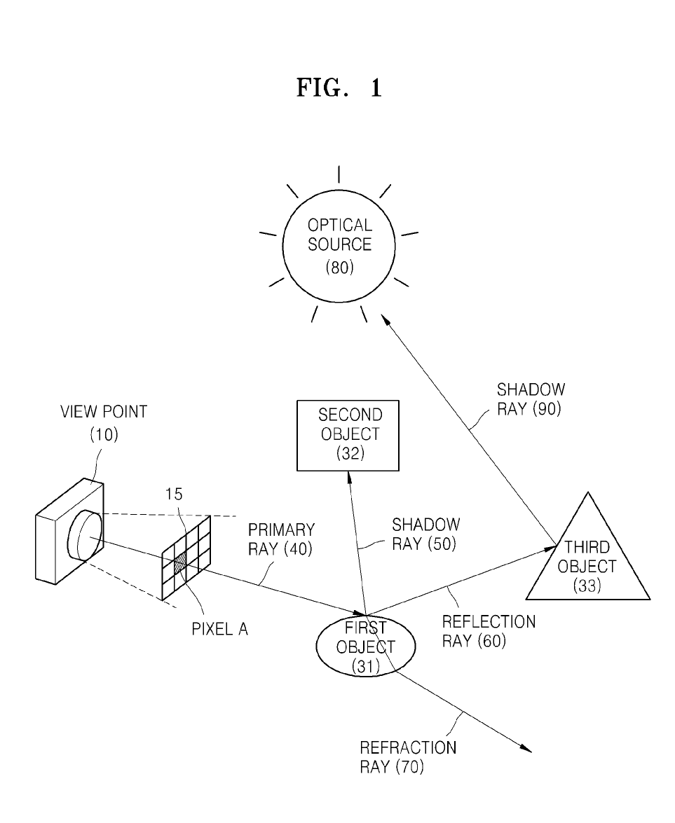

FIG. 1 is a diagram illustrating an example of a method of processing ray tracing. As shown in FIG. 1, 3-dimensional (3D) modeling may include an optical source 80, a first object 31, a second object 32, and a third object 33. In FIG. 1, the first to third objects 31 to 33 are represented as 2-dimensional objects for convenience, but they are 3D objects.

The first object 31 may have reflectance and refractive index greater than 0, and the second and third objects 32 and 33 have reflectance and refractive index of 0. The first object 31 reflects and refracts a light, and the second and third objects 32 and 33 do not reflect and refract a light.

In the 3D modeling as shown in FIG. 1, a rendering device (for example, a ray tracing processing apparatus) may determine a view point 10 to generate a 3D image, and determine a screen 15 according to the determined view point 10. When the view point 10 and the screen 15 are determined, the ray tracing processing apparatus 100 may generated a ray for each pixel of the screen 15 from the view point 10. For example, as shown in FIG. 1, when the screen 15 has a resolution of 4×3, a ray may be generated for each of the 12 pixels. Hereinafter, a ray for one pixel (pixel A) is described.

Referring to FIG. 1, a primary ray 40 for pixel A is generated from the view point 10. The primary ray 40 passes the 3D space and arrived at the first object 31. In this example, the first object 31 may be configured with a set of unit regions (hereinafter referred to as primitive). For example, the primitive may be a polygon, such as a triangle or a rectangle. Hereinafter, a primitive that is a triangle is described as an example.

A shadow ray 50, a reflection ray 60, and a refraction ray 70 may be generated at a hit point of the primary ray 40 and the first object 31. The shadow ray 50, the reflection ray 60, and the refraction ray 70 are referred to as secondary rays.

The shadow ray 50 is generated toward a direction of the optical source 80 from the hit point. The reflection ray 60 is generated in a direction corresponding to an incident angle of the primary ray 40, and given a weight according to the reflectance of the first object 31. The refractive ray 70 is generated in a direction corresponding to the incident angle of the primary ray 40 and the refractive index of the first object 31, and given a weight according to the refractive index of the first object 31.

The ray tracing processing apparatus 100 determines whether the hit point is exposed to the optical source 80 through the shadow ray 50. For example, as shown in FIG. 1, when the shadow ray 50 meets the second object 32, a shadow may be generated at the hit point of the corresponding shadow ray 50.

In addition, the ray tracing processing apparatus 100 determines whether the refractive ray 70 and the reflective ray 60 arrive at different objects. For example, as shown in FIG. 1, no objects are present in a direction that the refractive ray 70 travels, and the reflective ray 60 arrives at the third object 33. The ray tracing processing apparatus 100 confirms a coordinate of the hit point and color information of the third object 33, and generates the shadow ray 90 from the hit point of the third object 33. The ray tracing processing apparatus 100 determines whether the shadow ray 90 is exposed to the optical source 80.

Since the reflectance and the refractive index of the third object 33 are 0, the reflection ray and the refraction ray for the third object 33 are not generated.

As described above, the ray tracing processing apparatus 100 analyzes the primary ray 40 for pixel A and all rays derived from the primary ray 40 and determines a color value of pixel A according to the analyzed result. The determination of the color value of pixel A also depends on color of the hit point of the primary ray 40, color of the hit point of the reflection ray 60, and whether the shadow ray 50 arrives at the optical source 80.

The ray tracing processing apparatus 100 may perform the above-described operations on all the pixels of the screen 15.

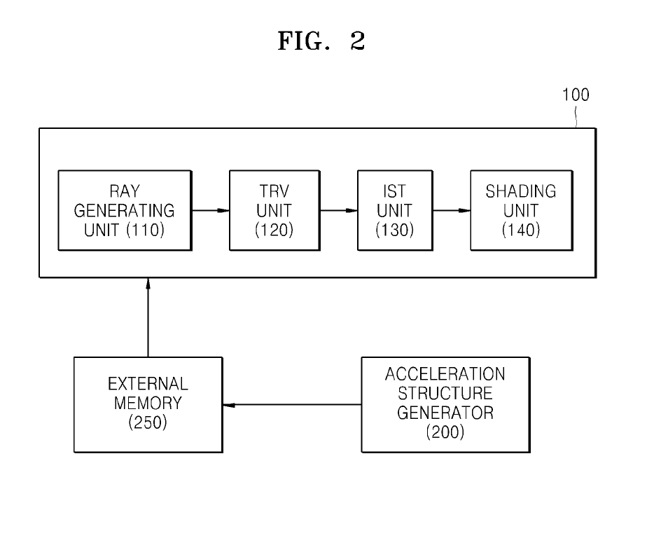

FIG. 2 is a diagram illustrating an example of a ray tracing processing system. Referring to FIG. 2, the ray tracing processing system may include a ray tracing processing apparatus 100, an external memory 250, and an acceleration structure generator 200. The ray tracing processing apparatus 100 may include a ray generating unit 110, a traversal (TRV) unit 120, an intersection (IST) unit 130, and a shading unit 140. In FIG. 2, the TRV unit 120 and the IST unit 130 are included in the ray tracing processing apparatus 100, but the TRV unit 120 and the IST unit 130 may also be provided separately without departing from the spirit and scope of the illustrative examples described. The ray tracing processing apparatus 100 of FIG. 2 only includes elements related to the illustrated example. However, it is understood that those skilled in the art may include other general elements in the ray tracing processing apparatus 100.

The ray generating unit 110 may generate a primary ray and rays derived from the primary ray. The ray generating unit 110, as described in FIG. 1, may generate the primary ray from a view point 10, and generate secondary rays at a hit point of the primary ray and an object. The secondary rays may be a reflection, refraction, or shadow ray generated at the hit point, i.e., the point at which the primary ray intersects with the object.

Furthermore, the ray generating unit 110 may generate tertiary rays at hit points at which the secondary rays intersect with the object. The ray generating unit 110 may generate rays continuously until the rays do not intersect with the object, or within a predetermined number of times.

The TRV unit 120 may receive information on the rays generated from the ray generating unit 110. The generated rays all include the primary ray, and rays derived from the primary ray (the secondary rays and the tertiary rays).

For example, for the primary ray, the TRV unit 120 may receive information on view points and directions of the generated rays. For the secondary rays, the TRV unit 120 may receive information on a starting point and directions of the secondary rays. The starting point of the secondary rays represents a point at which the primary ray intersects with the object. The view point and the starting point may be represented as coordinates, and the directions may be represented as vectors.

The TRV unit 120 may read information regarding an acceleration structure from the external memory 250. The acceleration structure is generated by an acceleration structure generator 200 and the generated acceleration structure is stored in the external memory 250.

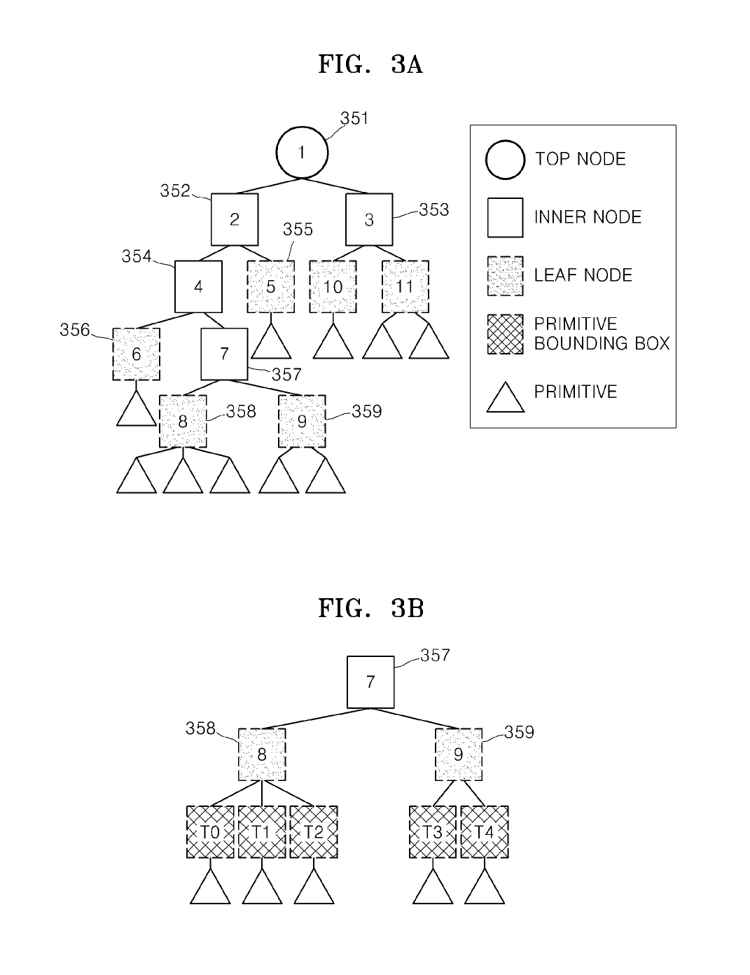

The acceleration structure generator 200 may generate the acceleration structure including position information of objects in a 3D space. The acceleration structure generator 200 divides the 3D space into a hierarchical tree type. The acceleration structure generator 200 may generate various types of acceleration structures. For example, the acceleration structure generator 200 may apply a K-dimensional tree (KD-tree) or a bounding volume hierarchy (BVH) to generate an acceleration structure which represents a relationship between the objects in the 3D space. This will be described in detail in relation to FIGS. 3A and 3B.

FIGS. 3A and 3B are diagrams illustrating examples of acceleration structures. FIG. 3A illustrates the KD-tree structure, and FIG. 3B illustrates the BVH structure.

Hereinafter, for convenience, each node is referred to as number, which is written in the corresponding node of the acceleration structure. For example, a node 351, which is drawn as a circle and number 1 is written in may be referred to as a first node 351, a node 352 which is drawn as a rectangle and number 5 is written in may be referred to as a second node 352, and a node 355 which is drawn as a rectangle with a broken line may be referred to as a fifth node 355.

Referring to FIG. 3A, the KD-tree may include a top node, inner nodes, leaf nodes, and primitives.

In FIG. 3A, the first node 351 represent the top node. The top node is the highest node, which does not have an upper layer node and only has lower layer nodes. For example, lower layer nodes of the first node 351 are the second and third nodes 352 and 353, and there is no upper layer node.

The second node 352 may be an inner node. The inner node may have both upper layer nodes and lower layer nodes. For example, the upper layer node of the second node 352 is the first node 351 and the lower layer nodes are a fourth node 354 and the fifth node 355.

An eighth node 358 may be the leaf node. The leaf node is the lowest node, which does not have a lower layer node and has only upper layer nodes. For example, the upper node of the eighth node 358 is a seventh node 357 and a lower layer node does not exist.

Moreover, the leaf node may include primitives, which exist in the leaf node. For example, as shown in FIG. 3A, a sixth node 356, which is the leaf node, includes one primitive, and the eighth node 358, which is also the leaf node, includes three primitives, and a ninth node 359, which is the leaf node, includes two primitives.

As illustrated in FIG. 3B, the BHV structure may include a top node, inner nodes, leaf nodes, primitive bounding boxes, and primitives. The top node, the inner nodes, the leaf nodes, and the primitives are the same as those in the KD-tree structure of FIG. 3A and descriptions about them are omitted.

Referring FIG. 3B, the leaf node includes the primitive bounding box. For example, as shown in FIG. 3B, an eighth node 358, which is the leaf node, includes three primitive bounding boxes T0, T1, and T2.

The primitive bounding box includes one primitive. For example, as shown in FIG. 3B, the primitive bounding boxes, T0, T1, T2, T3, and T4, each include one primitive.

Referring to FIG. 2, the TRV unit 120 traverses information on the acceleration structure and may detect a leaf node that a ray intersects.

At this time, the nodes and the primitive bounding boxes may be rectangular forms, and accordingly, a ray-node intersection test and a ray-primitive bounding box intersection test may be performed in the same manner.

The IST unit 130 may receive leaf nodes or primitive bounding boxes with which rays intersect. The IST unit 130 may read information (e.g. geometry data) on the primitives included in the received leaf nodes or in the primitive bounding boxes from the external memory 250. The IST unit 130 may perform the intersection test between the rays and primitives by using the information that it read on the primitives. For example, the IST unit 130 may test which primitive intersects with the rays from among the plurality of primitives included in the received leaf nodes and primitive bounding boxes from the TRV unit 120. Accordingly, the primitives intersecting with the rays can be detected, and hit points at which the detected primitives intersect with the rays can be calculated. The calculated hit points may be output to the shading unit 140 as a coordinate type. The shading unit 140 may determine color values of pixels on the basis of information on the hit points and material properties of the hit points. In addition, the shading unit 140 may determine the color values of the pixels in consideration of basic colors of the materials of the hit points and effects of an optical source. For example, for pixel A of FIG. 1, the shading unit 140 may determine a color value of pixel A by considering effects of the primary ray 40, and the secondary rays, i.e., the refraction ray 70, the reflection ray 60, and the shadow ray 50.

Furthermore, the ray tracing processing apparatus 100 may read data needed for ray tracing from the external memory 250. The external memory 250 may store the acceleration structure or geometry data. The acceleration structure is generated by the acceleration structure generator 200 and stored in the external memory 250. The geometry data represents information on the primitives. The primitives may be polygons, such as triangles or rectangles, and the geometry data may represent information on vertexes and positions of the primitives included in the objects. For example, when the primitive is a triangle, the geometry data may include vertex coordinates, normal vectors or texture coordinates with respect to three points of the triangles.

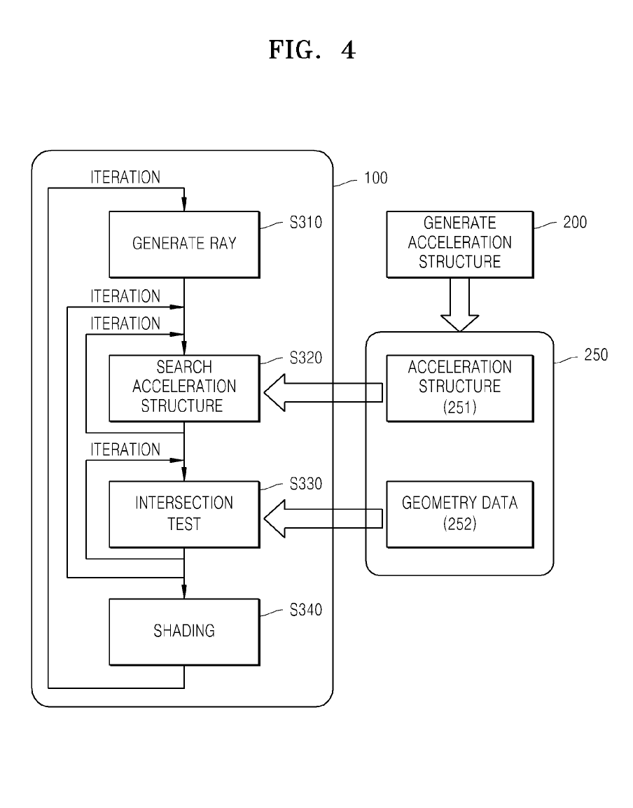

FIG. 4 is a diagram illustrating an example of a method of processing ray tracing of the ray tracing processing apparatus 100 shown in FIG. 2. Accordingly, description of FIG. 2 may also apply to the method of processing ray tracing of FIG. 4, and will not be repeated here. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently.

Referring to FIG. 4, in operation S310, the ray tracing processing apparatus 100 generates rays. The rays may include a primary ray generated from a view point and rays derived from the primary ray.

In operation S320, the ray tracing processing apparatus 100 reads an acceleration structure from the external memory 250, and traverses the acceleration structure based on the generated rays. The ray tracing processing apparatus 100 may detect leaf nodes or primitive bounding boxes with which rays intersect. The ray tracing processing apparatus 100 may continuously traverse the acceleration structure until the leaf nodes or the primitive bounding boxes with which rays intersect are detected. For example, the ray tracing processing apparatus 100 may perform ray-node intersection tests to detect the leaf nodes.

The ray tracing processing apparatus 100 traverses an acceleration structure along any one path, and, when a ray does not intersect with a leaf node on the traversed path, may traverse an acceleration structure along another path. For example, referring to FIG. 3A, the ray tracing processing apparatus 100 may start to traverse from the second node 352 or the third node 353, which is a lower layer node of the first node 351. When the traversal is started from the second node 352, the ray tracing processing apparatus 100 may store information on the third node 353 in a separate memory.

The ray tracing processing apparatus 100 may determine whether a ray intersects with the second node 352. When the ray intersects with the second node 352, any one of the fourth node 354 and fifth node 355, which is a lower layer node of the second node 352, may be traversed.

When a traversal is performed to determine whether the fourth node 354 intersects with the ray, the ray tracing processing apparatus 100 may store information on the fifth node 355, which is a remained node, in the separate memory.

When the ray intersects with the fourth node 354, the ray tracing processing apparatus 100 may traverse on any one of the sixth node 356 and the seventh node 357, which are lower layer nodes of the fourth node 354.

When a traversal is performed to determine whether the sixth node 356 intersects with the ray, the ray tracing processing apparatus 100 may store information on the seventh node 357, which is a remained node, in the separate memory.

When the sixth node 356 intersects with the ray, the ray tracing processing apparatus 100 may detect the sixth node 356 as a leaf node.

As described above, the ray tracing processing apparatus 100 may detect a leaf node by traversing along any one path. The ray tracing processing apparatus 100 may store information on the other nodes that it did not traverse on the same layer in a separate memory. When the traversal for the one path is completed, the ray tracing processing apparatus 100 may again traverse from a node corresponding to the most recently stored information. For example, after the sixth node 356 is detected as a leaf node, a traversal may be performed from the seventh node 357 corresponding to the most recently stored information.

Accordingly, when completing a traversal along one path, the ray tracing processing apparatus 100 does not traverses from the top node again, but from a path nearest to the path for which the traversal is completed. Thus, reducing the amount of calculation required.

When the leaf node is detected, the ray tracing processing apparatus 100 compares a state of the TRV unit, which detects the leaf node, and a state of the IST unit to feed information on the detected leaf node back to the TRV unit or to transmit it to the IST unit.

The ray tracing processing apparatus 100 may determine which unit of the TRV unit and the IST unit is in an idle state. For example, the ray tracing processing apparatus 100 compares a remnant data amount of an input buffer of the TRV unit and that of the IST unit. When the remnant data amount of the input buffer of the TRV unit is smaller than that of the IST unit, the ray tracing processing apparatus 100 determines that the TRV unit is in the idle state, and feeds the information on the detected leaf node back to the TRV unit.

In another example, the ray tracing processing apparatus 100 may determine which of the TRV unit and the IST unit is in an idle state on the basis of life spans (degrees of oldness) of data being processed in the TRV and IST units. When the life span of the data in processing in the TRV unit is longer than that in the IST unit, the TRV unit may be determined to be in the idle state. In addition, the data life span may be determined on the basis of the number of times of repetitive searches performed by the TRV unit.

The ray tracing processing apparatus 100 may detect the primitive bounding box by applying the above-described traversal method, which is used to detect the leaf node. For example, the ray tracing processing apparatus 100 performs a ray-primitive bounding intersection test to detect a primitive bounding box with which a ray intersects.

Moreover, the ray tracing processing apparatus 100 may transmit information on the detected primitive bounding box to the IST unit.

In comparing the remnant data amount of the input buffer of the TRV unit and that of the IST unit, when the remnant data amount of the input buffer of the IST unit is smaller, the ray tracing processing apparatus 100 determines that the IST unit is in an idle state and transmit the detected leaf node to the IST unit.

The ray tracing processing apparatus 100 may test whether primitives included in the detected leaf node or in the detected primitive bounding box intersect with rays.

In operation S330, the ray tracing processing apparatus 100 may read geometry data 252 on the primitives from the external memory 250 and perform intersection tests between the rays and the primitives by using the information that it read on the primitive.

The ray tracing processing apparatus 100 may test which primitive among the primitives included in the leaf node received from the TRV unit 120 intersects with the rays. For example, when the detected leaf node includes three primitives (first to third primitives), the ray tracing processing apparatus 100 performs intersection tests between the first primitive and the rays, between the second primitive and the rays, and between the third primitive and the rays to detect primitives with which rays intersect.

In another example, whether rays intersect with a primitive may be determined by performing intersection tests on the primitive included in the detected primitive bounding box and the rays.

In operation S340, the ray tracing processing apparatus 100 may perform shading on pixels on the basis of the intersection tests. That is, color values of the pixels may be determined on the basis of information on the hit points and material properties of the hit points.

After completing operation S340, the ray tracing processing apparatus 100 proceeds to operation S310. The ray tracing processing apparatus 100 performs operations S310 to S340 for shading other pixels after shading one pixel, and repeats operations S310 to S340 for all the pixels forming the screen.

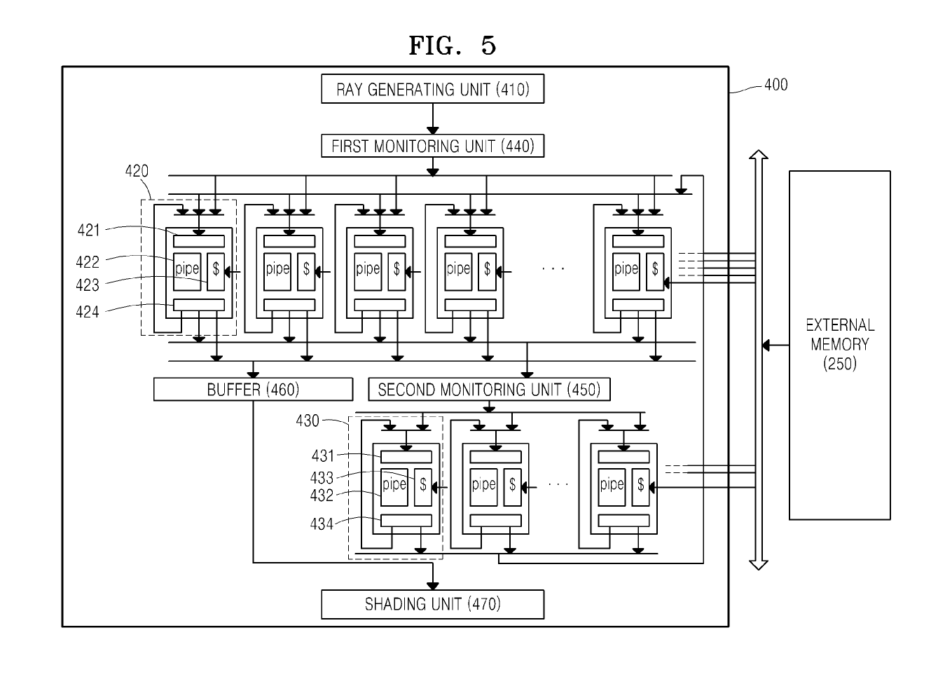

FIG. 5 illustrates an example of a diagram of a ray tracing processing apparatus. Referring to FIG. 5, the ray tracing processing apparatus 400 may include a ray generating unit 410, a plurality of TRV units 420, and a plurality of IST units 430, a shading unit 470, a first monitoring unit 440, a second monitoring unit 450, and a buffer 460. One TRV unit 420 may include a first input buffer 421, a first operation unit 422, a first cache 423, and a first determining unit 424. One IST unit 430 may include a second input buffer 431, a second operation unit 432, a second cache 433, and a second determining unit 434.

Since the ray generating unit 410 corresponds to the ray generating unit 110 of FIG. 2 and the external memory 250 corresponds to the external memory 250 of FIG. 2, descriptions of the ray generating unit 110 and the external memory 250 of FIG. 2 also apply to the ray generating unit 410 and the external memory 250 of FIG. 5, and will not be repeated here.

The first monitoring unit 440 may monitor states of the input buffers 421 of the plurality of TRV units 420. For example, the first monitoring unit 440 may monitor each remnant data amount of the input buffers of the TRV units 420 or an average remnant data amount of the input buffers of the TRV units 420.

The first operation unit 422 may traverse which leaf node in an acceleration structure is associated with a ray input from the input buffer 421 (ray-node intersection test), or which primitive bounding box in the acceleration structure is associated with the input ray (ray-primitive bounding box intersection test). Data for the acceleration structure, obtained from the external memory 250, may be stored in the first cache 423. The first operation unit 422 may traverse the acceleration structure rapidly by using the data stored in the first cache 423.

Also, the first operation unit 422 may be configured with multipliers in order to perform the ray-node intersection test and the ray-primitive bounding box intersection test. The second monitoring unit 450 may monitor the state of the input buffers 431 of the plurality of IST units 430. For example, the second monitoring unit 450 may monitor each remnant data amount of the input buffers of the IST units 430 or an average remnant data amount of the input buffers of the IST units 430.

The second operation unit 432 may test whether the input ray interests with primitives included in the detected leaf node or a primitive included in the detected primitive bounding box in the TRV unit 420, and calculate hit points (ray-primitive intersection test).

Geometry data for the primitives may be stored in the second cache (a primitive cache) 433 from the external memory 250, and the second operation unit 432 may rapidly read the primitive data by using data stored in the second cache 433. The second operation unit 432 may be configured with multipliers and dividers in order to perform the ray-primitive intersection tests. The second operation unit 432 of the IST unit 430, as described above, includes all the multipliers and dividers. The dividers have larger area than the multipliers, and a relatively larger portion of the circuit manufacturing cost is incurred for the dividers.

The ray tracing processing apparatus 100 is configured to have the larger number of TRV units 420 than the number of IST units 430 and performs the ray-primitive bounding intersection tests in the TRV units 420 before performing the ray-primitive intersection tests in the IST units 430. Thus, calculation amounts of the TRV units 420 may be greater and calculation amounts of the IST units 430 may be lesser.

However, when the ray-primitive bounding box intersection tests are unconditionally performed in the TRV units 420, the IST units become idle and calculation amounts of the TRV units 420 may be excessively increased.

To better utilize resources, the first determining unit 424 and the second determining unit 434 may properly distribute a ray to the TRV unit 420 or the IST unit 430 based on monitoring the states of the TRV unit 420 and the IST unit 430.

When the first operation unit 422 detects the leaf node intersecting with the ray, the first determining unit 424 may feed the ray back to the first input buffer 421 or transmit the ray to the IST unit 430 based on monitoring the state of the first input buffer 421 and the input buffer 431 of the IST unit 430.

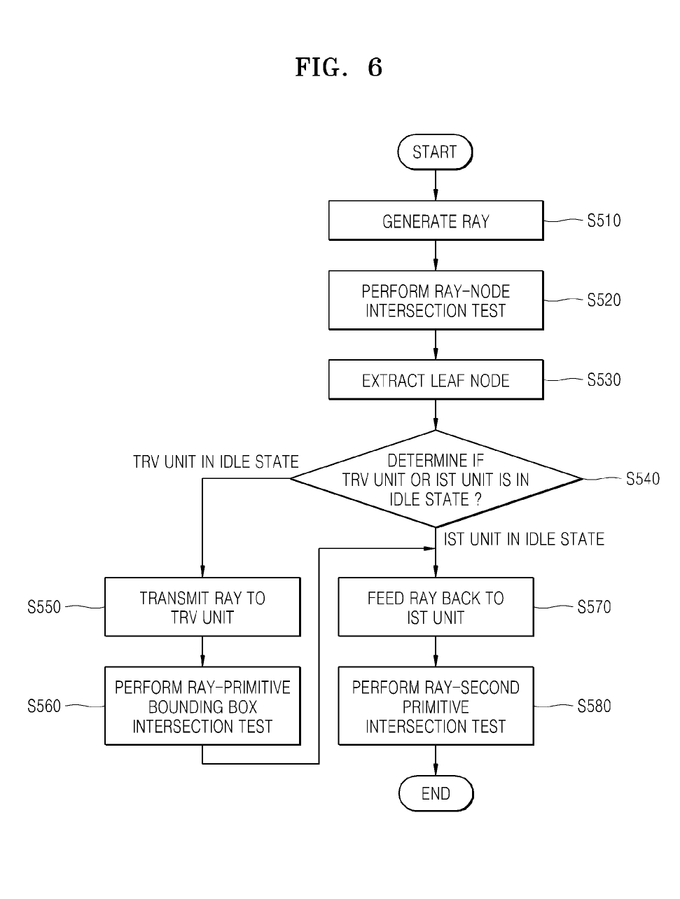

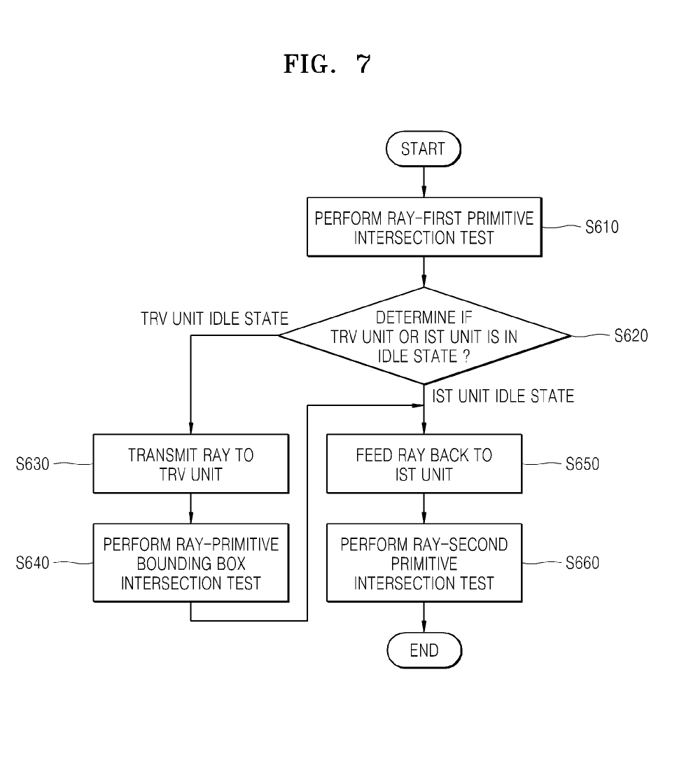

When the second operation unit 432 may detect the primitives intersecting with the ray to calculate hit points, the second determining unit 434 may feed the ray back to the second input buffer 431 or transmit the ray to the TRV unit 420 based on monitoring the states of the second input buffer 431 and the input buffer of the TRV unit 420. These operations are described in detail later in relation to FIGS. 6 and 7.

Moreover, the buffer 460 may temporally store the hit point information calculated in the second operation unit 432. For example, the calculated hit point information may be stored until all the hit points for one pixel are calculated.

The shading unit 470 may determine color values of pixels on the basis of hit point information temporally stored in the buffer 460 and material properties of the hit points.

FIGS. 6 and 7 are diagrams illustrating a ray tracing processing method. The operations in FIGS. 6 and 7 may be performed in the sequence and manner as shown, although the order of some operations may be changed or some of the operations omitted without departing from the spirit and scope of the illustrative examples described. Many of the operations shown in FIGS. 6 and 7 may be performed in parallel or concurrently. The above descriptions of FIGS. 1-5, is also applicable to FIGS. 6 and 7, and is incorporated herein by reference. Thus, the above description may not be repeated here.

Referring to FIG. 6, in operation S510, the ray tracing processing apparatus 400 generates rays. In operation S520, the ray tracing processing apparatus 400 performs a ray-node intersection test based on the acceleration structure to traverse a node with which the ray intersects. In operation S530, the ray tracing processing apparatus 400 detects a leaf node ( ).

When the leaf node is detected, in operation S540, the ray tracing processing apparatus 400 compares the states of the TRV units and the states of the IST units. As described below, according to the result of the comparison, the ray tracing processing apparatus 400 feeds the ray back to the TRV units in operation S550, or transmit the ray to the IST units in operation S570.

In a non-exhaustive example, after detecting the leaf node, in S540, it may be determined that the TRV units are in idle state. The ray tracing processing apparatus 400 compares a remnant data amount of the first input buffer 421 and the average remnant data amount of the input buffers of the IST units 430. When the remnant data amount of the first input buffer is smaller, i.e, when a state of the first input buffer has greater room for storing than states of the input buffers of the IST units (TRV units are in idle states), the ray tracing processing apparatus 400 may feed the ray back to the first input buffer 421 of the TRV unit (operation S550).

In operation S560, the first operation unit 422 may detect a first bounding box among primitive bounding boxes included in a leaf node where the fed ray is detected.

When the first operation unit 422 detects the intersecting first primitive bounding box, in operation S570, the ray is input to the second input buffer 431 of the IST unit. In operation S580, the second operation unit 432 may test whether the ray intersects with a first primitive on the basis of geometry data for the first primitive included in the first primitive bounding box.

The geometry data for the first primitive may be obtained from the external memory and may be stored in the second cache (the primitive cache) 433. The second operation unit 432 may rapidly read the first primitive data by using data stored in the second cache 433. When the ray intersects with the first primitive included in the first primitive bounding box, the second operating unit 432 may calculate hit points.

In another non-exhaustive example, in S540, after detecting the leaf node, it may be determined that the IST units are in idle state. When the average remnant data amount of the input buffers of the IST units 430 is smaller than the remnant data amount of the first input buffer 421, i.e., when the states of the input buffers of the IST units have greater room for storing than the state of the first input buffer 421, in operation S570, the first determining unit 424 may transmit the ray to the input buffers of the IST units.

In operation S580, the second operation unit 432 tests whether the ray intersects with the first primitive among the primitives included in the leaf node on the basis of geometry data for the primitives included in the leaf node detected in the first operation unit 422.

The geometry data for the primitives may be obtained from the external memory 250 and may be stored in the second cache (the primitive cache) 433. The second operation unit 432 may rapidly read the primitive data by using data stored in the second cache 433. When the ray intersects with the first primitive, the second operation unit 432 may calculate hit points.

As described above, in operation S610, the second operation unit 432 completes a check whether the ray intersects with the first primitive and the hit point calculation. In operation S620, the second determining unit 434 may feed the ray back to the IST units 430 or transmit the ray to the TRV units 420 for performing an operation on a second primitive (another primitive included in the leaf node) according to a result of monitoring the state of the second input buffer 431 and the states of the input buffers of the TRV units.

In a non-exhaustive example, it may be determined that the IST unit are in idle state after the ray-first primitive intersection test. When a remnant data amount of the second input buffer 431 is compared with an average remnant data amount of the input buffers of the TRV units 420, and the remnant data amount of the second input buffer 431 is smaller, i.e., when a state of the second input buffer 431 has greater room for storing than the states of the input buffers of the TRV units, in operation S650, the second determining units 434 may feed the ray back to the second input buffer 431 of the IST unit.

In operation S660, the second operating unit 432 tests whether the ray intersects with the second primitive on the basis of the geometry data for the second primitive included in the leaf node. In addition, when the ray intersects with the second primitive, the second operation unit 432 may calculate hit points.

In a non-exhaustive example, it may be determined that the TRV units are in idle state after the ray-first primitive intersection test

When the average remnant data amount of the input buffers of the TRV units 420 is smaller than the remnant data amount of the second input buffer 431, i.e., when the states of the input buffers of the TRV units 420 have rooms for storing than the state of the second buffer 431, the second determining unit 434 may transmit the ray again to the TRV units 420 (operation S630).

In operation S640, the first operation unit 422 may detect the intersecting second bounding box among the primitive bounding boxes included in the leaf node where the ray is detected.

In operation S650, when the first operation unit 422 detects the intersecting second bounding box, the ray is input to the second input buffer 431 of the IST unit. In operation S660, the second operation unit 422 tests whether the ray intersects with the second primitive included in the second bounding box on the basis of the geometry data for the second primitive included in the second bounding box detected by the first operation unit 422.

Furthermore, as described above, the second operation unit 432 completes a check whether the ray intersects with the second primitive and performs hit point calculation. The second determining unit 434 may feed the ray back to the IST units 430 or transmits the ray to the TRV units 420 according to a result of monitoring the state of the second buffer 431 and the states of the input buffers of the TRV units 420 until tests for the bounding boxes or the primitives included in the leaf node are performed.

When primitives intersecting with the ray among primitives included in a first leaf node are all detected by applying the above-described methods, the second determining unit 434 may transmits the ray to the TRV units 420 for detecting a second leaf node intersecting with the ray.

As described above, when a leaf node is detected by performing a ray-node intersection test in a TRV unit, calculation amounts in the TRV unit and an IST unit may be adjusted by determining whether a ray-primitive bounding box intersection test or a ray-primitive intersection test is performed according to the state of the TRV unit and the IST unit.

In addition, even after the ray-primitive intersection test is completed, the calculation amounts in the TRV unit and the IST unit may be adjusted by determining whether the ray-primitive bounding box intersection test or the ray-primitive intersection test is performed for a next primitive according to the state of the TRV unit and the IST unit.

Accordingly, by properly using the TRV units and the IST units, the ray tracing processing capability and processing speed can be improved. As described above, processing capability of a ray tracing apparatus can be enhanced by minimizing idle states of TRV units and IST units. Load can be balanced regardless of the number of TRV units and IST units. Since primitive bounding box intersection tests can be performed by using existing TRV units, separate hardware units are not needed. Since redundant ray-primitive intersection tests can be precluded by performing the primitive bounding box intersection tests, ray tracing processing speed can be enhanced.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A ray tracing processing method comprising:
detecting, at a ray tracing processing apparatus, a leaf node with which an input ray intersects; and
in response to the leaf node being detected, comparing a state of a traversal (TRV) unit and a state of an intersection test (IST) unit and determining whether to feed the ray back to the TRV unit or to transmit the ray to the IST unit.

2. The method of claim 1, wherein the determining of whether to feed the ray back to the TRV unit or to transmit the ray to the IST unit comprises feeding the ray back to the TRV unit, in response to the TRV unit being in an idle state, and transmitting the ray to the IST unit, in response to the IST unit being in an idle state.

3. The method of claim 1, wherein the determining of whether to feed the ray back to the TRV unit or to transmit the ray to the IST unit comprises determining whether to feed the ray back to the TRV unit or to transmit the ray to the IST unit based on comparing a remnant data amount of an input buffer of the TRV unit and a remnant data amount of an input buffer of the IST unit.

4. The method of claim 3, wherein the determining of whether to feed the ray back to the TRV unit or to transmit the ray to the IST unit comprises:
feeding the ray back to the TRV unit, in response to the remnant data amount of the input buffer of the TRV unit being smaller than that of the IST unit; and
transmitting the ray to the IST unit, in response to the remnant data amount of the input buffer of the IST unit being smaller than that of the TRV unit.

5. The method of claim 1, further comprising:
detecting a primitive bounding box included in the detected leaf node with which the ray intersects, in response to the ray being fed back to the TRV unit; and
determining whether the ray intersects with a primitive included in the detected primitive bounding box; and
calculating a hit point, in response to the ray intersecting with the primitive.

6. The method of claim 5, wherein the primitive bounding box comprises a single primitive.

7. The method of claim 1, further comprising:
determining whether the ray intersects with a primitive included in the detected leaf node, in response to the ray being transmitted to the IST unit; and
calculating a hit point, in response to the ray intersecting with the primitive.

8. The method of claim 7, further comprising:
after determining whether the ray intersects with the primitive, comparing a state of the TRV unit and a state of the IST unit and determining whether to feed the ray back to the IST unit or to transmit the ray to the TRV unit; and
in response to the ray being transmitted to the TRV unit:
detecting a second primitive bounding box included in the detected leaf node with which the ray intersects;
determining whether the ray intersects with a second primitive included in the detected second primitive bounding box; and
calculating a second hit point, in response to the ray intersecting with the second primitive.

9. The method of claim 8, further comprising:
determining whether the ray intersects with the second primitive included in the detected leaf node, in response to the ray being fed back to the IST unit; and
calculating a second hit point, in response to the ray intersecting with the second primitive.

10. The method of claim 5, wherein the node and the primitive bounding box are rectangles.

11. A non-transitory computer readable storage medium having a program to cause a computer to perform the method of claim 1.

12. A ray tracing processing apparatus comprising:
a first operator configured to detect a leaf node with which a ray intersects; and
in response to the leaf node being detected a first determiner configured to compare a state of a TRV unit and a state of an IST unit to determine whether to feed the ray back to the TRV unit or to transmit the ray to the IST unit.

13. The apparatus of claim 12, wherein, the first determiner is further configured to feed the ray back to the TRV unit in response to the TRV unit being determined to be in an idle state, and to transmit the ray to the IST unit in response to the IST unit being determined to be in an idle state.

14. The apparatus of claim 12, wherein the first determiner is further configured to compare a remnant data amount of an input buffer of the TRV unit with a remnant data amount of an input buffer of the IST unit to determine whether to feed the ray back to the TRV unit or to transmit the ray to the IST unit.

15. The apparatus of claim 14, wherein the first determiner is further configured to feed the ray back to the TRV unit in response to the remnant data amount of the input buffer of the TRV unit being smaller than that of the IST unit, and to transmit the ray to the IST unit in response to the remnant data amount of the input buffer of the IST unit being smaller than that of the TRV unit.

16. The apparatus of claim 12, wherein the first operator is further configured to detect a primitive bounding box included in the detected leaf node with which the ray intersects, in response to the ray being fed back to the TRV unit, and a second operator configured to determine whether the ray intersects with the primitive included in the detected primitive bonding box, and to calculate a hit point in response to the ray intersecting with the primitive.

17. The apparatus of claim 16, wherein the primitive bounding box comprises a single primitive.

18. The apparatus of claim 16, further comprising a second operator configured to determine whether the ray intersects with the primitive included in the detected leaf node, in response to the ray being transmitted to the IST unit, and to calculates a hit point, in response to the ray intersecting with the primitive.

19. The apparatus of claim 18, further comprising a second determiner configured to compare a state of the TRV unit and a state of the IST unit to determine whether to feed the ray back to the IST unit or transmit the ray to the TRV unit, after determining whether the primitive intersects with the ray; and
in response to the ray being transmitted to the TRV unit:
the first operator is further configured to detect a second primitive bounding box included in the detected leaf node with which the ray intersects, and
the second operator is further configured to determine whether the ray intersects with a second primitive included in the detected second primitive bounding box and to calculate a second hit point, in response to the ray intersecting with the second primitive.

20. The apparatus of claim 19, wherein, in response to the ray being fed back to the IST unit, the second operator is further configured to determine whether the ray intersects with the second primitive included in the detected leaf node, and to calculate the second hit point in response to the ray intersecting with the second primitive.
